(19) United States
(12) Patent Application Publication
(10) Pub. No.: US 2017/0022981 A1
(43) Pub. Date: Jan. 26, 2017

(54) Pendulum-type lever power generation device and method thereof

(71) Applicant: Siu Hong Sun, Hongkong (CN)

(72) Inventor: Siu Hong Sun, Hongkong (CN)

(21) Appl. No.: 15/136,970

(22) Filed: Apr. 24, 2016

(30) Foreign Application Priority Data
Apr. 24, 2015 (CN) 201510197793.5
Apr. 24, 2015 (CN) 201520253405.6

(51) Int. Cl. F03G 3/06; H02K 7/06; H02K 7/18

(52) U.S. Cl. CPC F03G 3/06; H02K 7/1853; H02K 7/06; F03G 2730/07; F03G 7/10

(57) ABSTRACT

A pendulum-type lever power generation device includes a swinging device. The swinging device includes: a base; an outer swinging component, which is connected to the base at a first pivot and able to swing around the first pivot with respect to the base; an inner swinging component, which is connected to the outer swinging component at a second pivot and able to swing around the second pivot with respect to the outer swinging component, wherein the second pivot is different from the first pivot; and a friction device, which contacts the inner swinging component in a relative sliding manner. The power generation device further includes: a power input device, which is coupled to the outer swinging component, for driving the outer swinging component to swing around the first pivot; and a power output device, which is coupled to the friction device and a power generation part.

### CROSS REFERENCE OF RELATED APPLICATION

The application claims priority under 35 U.S.C. 119(a-d) to CN 201520253405.6, filed Apr. 24, 2015 and CN 201510197793.5, filed Apr. 24, 2015.

### BACKGROUND OF THE PRESENT INVENTION

Field of Invention

The present invention relates to a power generation device and a method thereof, and more particularly to a pendulum-type lever power generation device with a simple structure, no environmental pollution, and a high energy conversion efficiency, and a method thereof.

Description of Related Arts

The conventional power generation methods in the prior arts, such as the thermal power generation and the hydropower generation, have a huge negative effect on the ecological environment and need a large capital input and a relatively long capital recovery cycle. The emerging power generation methods, such as the wind power generation, the tidal power generation, and the solar power generation, have a relatively small negative effect on the environment, but strongly depend on the environment. Moreover, the devices, needed by the emerging power generation methods, are relatively complex and have a low energy conversion efficiency.

Therefore, the present invention provides a pendulum-type lever power generation device, having a simple structure and a high energy conversion efficiency. Moreover, the pendulum-type lever power generation device has little dependence on the environment and is able to be widely applied in the various situations of the daily life. Furthermore, the scale application of the power generation device of the present invention is easily realized, so as to easily meet the various requirements of the energy input density and output density.

### SUMMARY OF THE PRESENT INVENTION

An object of the present invention is to provide a pendulum-type lever power generation device. The pendulum-type lever power generation device comprises a swinging device. The swinging device comprises: a base; an outer swinging component, which is connected to the base at a first pivot and able to swing around the first pivot with respect to the base; an inner swinging component, which is connected to the outer swinging component at a second pivot and able to swing around the second pivot with respect to the outer swinging component, wherein the second pivot is different from the first pivot; and a friction device, which contacts the inner swinging component in a relative sliding manner, so as to convert a swing of the inner swinging component into a rotation of the friction device around a third pivot and/or a fourth pivot. The power generation device further comprises: a power input device, which is coupled to the outer swinging component, so as to drive the outer swinging component to swing around the first pivot; and a power output device, which is coupled to the friction device and a power generation part, so as to convert a rotational kinetic energy of the friction device into an electric energy.

Preferably, the outer swinging component comprises at lease two supporters which are connected with each other through connecting rods; a bottom of each supporter is pivotally connected to the base, so as to form the first pivot; and a pin shaft, which is pivotally rotatable, is provided between tops of the adjacent supporters, so as to form the second pivot.

Further preferably, each supporter of the outer swinging component is triangular; each supporter is pivotally connected to the base at a middle position of the bottom of each supporter; and the pin shaft is located between top points of the adjacent supporters of the outer swinging component.

Preferably, the inner swinging component is fixedly connected to the pin shaft at a top of the inner swinging component.

Further preferably, the inner swinging component comprises a supporter which is triangular; the supporter of the inner swinging component is fixedly connected to the pin shaft at a top point of the supporter; and a bottom of the supporter of the inner swinging component has a sliding block structure.

Preferably, a counterweight is provided inside the supporter of the inner swinging component.

Preferably, the friction device comprises a side shaft and a friction wheel fixedly connected to the side shaft; wherein: the side shaft limits the third pivot and/or the fourth pivot; and the friction wheel contacts the sliding block structure in the relative sliding manner.

Preferably, the friction device is provided between corresponding sides of the adjacent supporters of the outer swinging component or at the base.

Preferably, the power output device comprises a flywheel which is connected to the side shaft and the power generation part.

Preferably, the power input device is connected to a top of the outer swinging component.

Preferably, the outer swinging component comprises three or more than three supporters; and one inner swinging component is provided between each two adjacent supporters of the outer swinging component.

Another object of the present invention is to provide a pendulum-type lever power generation method, comprising steps of: providing the outer swinging component having the first pivot, the inner swinging component having the second pivot which is different from the first pivot, and the friction device; providing a power input for swinging the outer swinging component with respect to the first pivot; connecting the inner swinging component to the outer swinging component at the second pivot for driving the inner swinging component to swing through a swing of the outer swinging component; providing the friction device at a position where the friction device is able to contact the inner swinging component in the relative sliding manner, for driving the friction device to rotate through the swing of the inner swinging component; and providing a power output, for converting the rotational kinetic energy of the friction device into the electric energy.

Preferably, the first pivot is provided at a bottom of the outer swinging component, and the second pivot is provided at the top of the inner swinging component.

Preferably, a rotational or translational power input is provided to the top of the outer swinging component, for swinging the outer swinging component with respect to the first pivot.

Preferably, an intermittent rotational or translational power input is provided to the outer swinging component.

Preferably, when the inner swinging component swings to a highest point, the outer swinging component swings in an opposite direction.

Preferably, a plurality of the supporters which are connected with each other through the connecting rods are provided for the outer swinging component, and a height of the supporters of the outer swinging component is determined according to the power input or an expected power output.

Preferably, the plurality of the supporters which are connected with each other through the connecting rods are provided for the outer swinging component, and an amount of the supporters of the outer swinging component is determined according to the power input or the expected power output.

Preferably, the counterweight is provided for the inner swinging component, and a weight of the counterweight is determined according to the power input or the expected power output.

These and other objectives, features, and advantages of the present invention will become apparent from the following detailed description, the accompanying drawings, and the appended claims.

### BRIEF DESCRIPTION OF THE DRAWINGS

For a better understanding of the present invention, the present invention is further illustrated with accompanying drawings.

FIG. 1 is a perspective view of a pendulum-type lever power generation device according to a preferred embodiment of the present invention.

FIG. 2 is a front view of the pendulum-type lever power generation device according to the preferred embodiment of the present invention.

FIG. 3 is a left view of the pendulum-type lever power generation device according to the preferred embodiment of the present invention.

FIG. 4 is a sketch view of a working condition of the pendulum-type lever power generation device according to the preferred embodiment of the present invention.

### DETAILED DESCRIPTION OF THE PREFERRED EMBODIMENT

The present invention is further illustrated with accompanying drawings, and the preferred embodiment of the present invention as shown in the drawings and described below is exemplary only and not intended to be limiting.

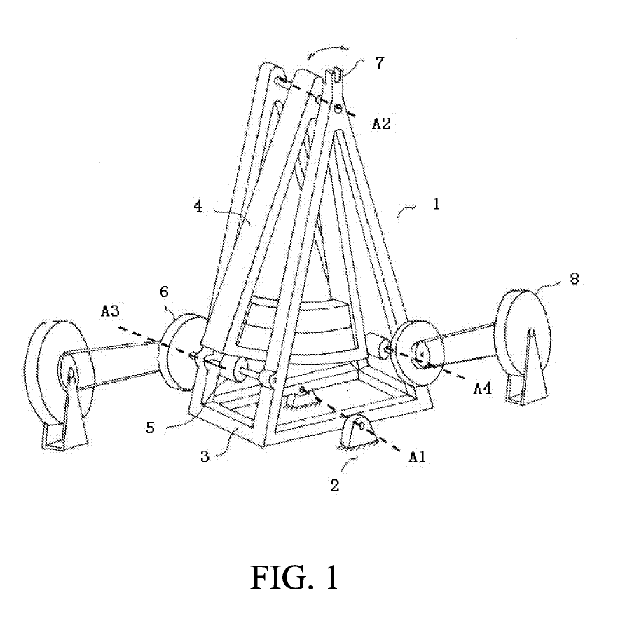

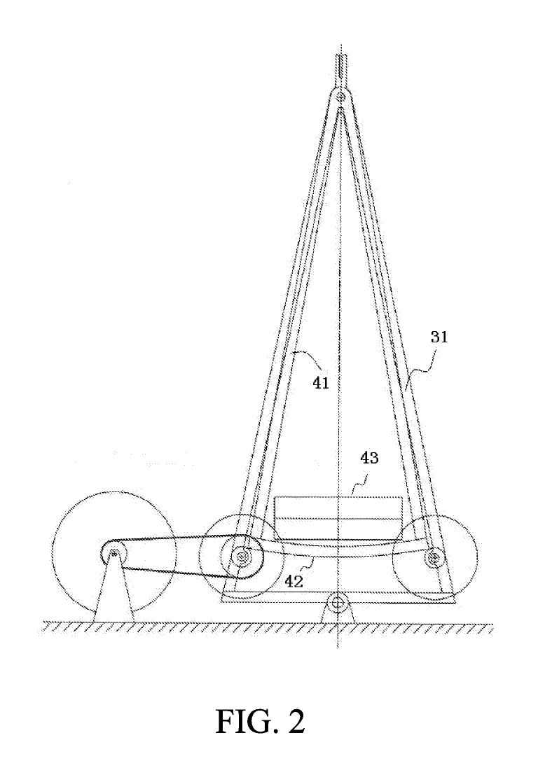

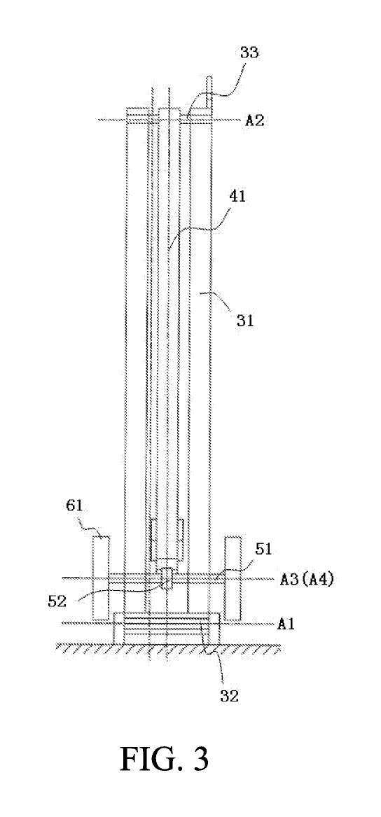

Referring to FIGS. 1-3, according to a preferred embodiment of the present invention, a pendulum-type lever power generation device is illustrated, which mainly comprises a swinging device 1, a power input device and a power output device 6.

The swinging device 1 comprises a base 2, an outer swinging component 3, an inner swinging component 4, and friction devices 5, wherein the outer swinging component 3 and the inner swinging component 4 are preferably frame-structured, so as to provide enough intensity while decreasing a weight and a material cost.

The outer swinging component 3 is preferably embodied to comprise at least two supporters 31 which are rectangular, wherein each two adjacent triangular supporters 31 are connected with each other through a plurality of connecting rods 32 which extend laterally. According to requirements, it is convenient to increase an amount of the rectangular supporters 31, so as to expand a capacity of the power generation device. Furthermore, a plurality of the triangular supporters 31 and the connecting rods 32 are able to be integrally formed, so as to provide a higher intensity.

Each triangular supporter 31 is preferably pivotally connected to the base 2 at a pivot point of a bottom of each supporter 31. The pivot points on the bottoms of the triangular supporters 31 are located on a same line (namely, a first pivot A1), so that the outer swinging component 3 is able to swing between an equilibrium position and two deflection positions with respect to the first pivot A1 at the bottom. Each pivot point is preferably located at a middle position of the corresponding bottom, so that the two deflection positions are mirror-symmetrical with respect to the equilibrium position. Moreover, according to an actual situation, it is also feasible not to provide the pivot point at the middle position of the corresponding bottom, and meanwhile the two deflection positions are not symmetrical with respect to the equilibrium position.

A second pivot A2 is provided between top points of the two adjacent triangular supporters 31. It is feasible to provide a bearing at the top point of each triangular supporter 31, and a pin shaft 33 extends between the adjacent bearings. When the amount of the triangular supporters 31 is larger than two, it is feasible to provide a pin shaft 33 between each two adjacent triangular supporters 31 or a single pin shaft 33 extending through a plurality of the bearings. Thus, the pin shaft 33 is able to rotate with respect to each triangular supporter 31. Certainly, any other suitable structure is feasible.

A third pivot A3 and a fourth pivot A4 are respectively provided at two sides of the triangular supporters 31. The third pivot A3 and the fourth pivot A4 are provided in a similar manner as the second pivot A2, and therefore the friction devices 5 are provided between the adjacent triangular supporters 31. Each friction device 5 comprises a side shaft 51 which is provided between the corresponding sides of the two adjacent triangular supporters 31. The side shaft 51 is able to rotate with respect to the corresponding triangular supporters 31 where the side shaft 51 is provided. Every friction device 5 further comprises a friction wheel 52 provided on the side shaft 51. The friction wheel 52 is connected with the side shaft 51 and unable to rotate with respect to the side shaft 51. Furthermore, the friction wheel 52 and the side shaft 51 are able to be integrally formed.

Furthermore, it is feasible not to provide every friction device 5 (namely the third pivot A3 and the fourth pivot A4) on the triangular supporters 31, but at a position where the friction device 5 is fixed and able to rotate with respect to the base 2. The position is preferably located inside each triangular supporter 31, without interference in swinging of each triangular supporter 31.

Furthermore, the supporters 31 of the outer swinging component 3 are not limited to be triangular, and any other suitable structure is feasible. Accordingly, positions of the first pivot A1, the second pivot A2, the third pivot A3, and the fourth A4 are required to be reasonably arranged.

The inner swinging component 4 is preferred to comprise a triangular supporter 41. The supporter 41 of the inner swinging component 4 is provided between the two adjacent supporters 31 of the outer swinging component 3, and an amount of the supporter 41 of the inner swinging component 4 is not limited to be one. The triangular supporter 41 of the inner swinging component 4, at a top point thereof, is fixedly connected to the pin shaft 33 (namely the second pivot A2) of the outer swinging component 3. Thus, the triangular supporter 41 of the inner swinging component 4 is able to swing with respect to the supporter 31 of the outer swinging component 3. Furthermore, the pin shaft 33 is fixedly connected between the adjacent supporters 31 of the outer swinging component 3, and the supporter 41 of the inner swinging component 4 is able to rotate with respect to the pin shaft 33.

The triangular supporter 41 of the inner swinging component 4 is preferably frame-structured, and at least one counterweight 43 is provided in the supporter 41 of the inner swinging component 4. The counterweight 43 is provided in the triangular supporter 41 of the inner swinging component 4 in a detachable manner. The counterweight 43 is provided in a modularized manner, so as to provide the counterweight 43 having an expected amount and weight according to requirements. Furthermore, the counterweight 43 is feasible to be an undetachable part of the inner swinging component 4.

A bottom of the triangular supporter 41 of the inner swinging component 4 has a sliding block structure 42. When every friction device 5 is provided on the outer swinging component 3, the sliding block structure 42 is arc-shaped, and a circle center of the sliding block structure 42 is located at the second pivot A2 where the triangular supporter 41 of the inner swinging component 4 is connected with the supporters 31 of the outer swinging component 3. Thus, when the inner swinging component 4 swings with respect to the outer swinging component 3, the sliding block structure 42 contacts the friction wheel 52 provided on the outer swinging component 3 in a relative sliding manner, so as to drive the friction wheel 52 to rotate. When every friction device 5 is provided on the base 2, the sliding block structure 42 is not limited to be arc-shaped, and the circle center of the sliding block structure 42 is not limited to be overlapping with the second pivot A2 where the triangular supporter 41 of the inner swinging component 4 is connected with the supporters 31 of the outer swinging component 3. Furthermore, the sliding block structure 42 is feasible to be a specific arc, which is easily obtained through track enveloping.

Furthermore, the supporter 41 of the inner swinging component 4 is not limited to be triangular, and any other suitable structure is feasible.

The power input device is provided for the swinging device 1. The power input device is able to be provided in various manners, and thus not showed in figures. The power input device is for driving the outer swinging component 3 to swing with respect to the first pivot A1. It is feasible to provide an input interface 7 at the top point of one triangular supporter 31 of the outer swinging component 3. The power input device is connected with the input interface 7. The power input device provides a rotational input, so that the outer swinging component 3 swings with respect to the first pivot A1, while it is also feasible for the power input device to provide a translational input for pushing and pulling the outer swinging component 3 to swing with respect to the first pivot A1.

A power source of the power input device is diversified. The sources of the power input comprise: motors; a redundant power of engines of motor vehicles, ships and air vehicles, such as the redundant power of common devices in daily life comprising bicycles and fitness equipments; common powers in nature, such as a wind power, a water power, and a tidal power; and any other device which is able to generate power. How to convert the power into the power input which is able to drive the outer swinging component 3 to swing is not a key point of the present invention.

The power output device 6 is provided for every friction device 5. The power output device 6 is for outputting a rotational energy of the friction wheel 52 to the power generation part 8 for converting. The side shaft 51, on which the friction wheel 52 is provided, extends outside the adjacent supporters 31 of the outer swinging component 3. The power output device 6 comprises a flywheel 61. The flywheel 61 is connected with the power generation part 8, so as to convert a rotational kinetic energy of the friction wheel 52 into electric energy. Certainly, any other suitable power output device 6 is feasible.

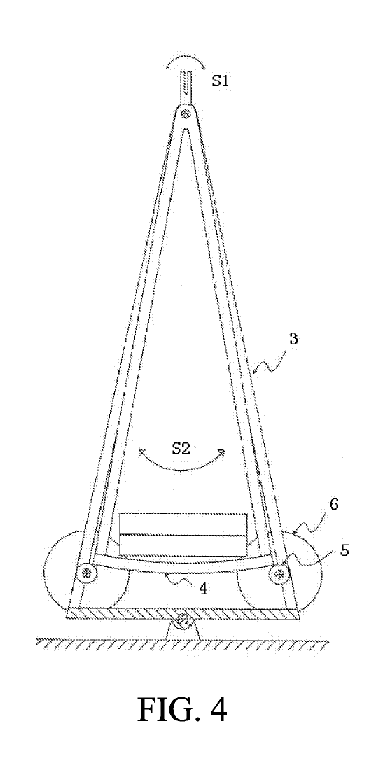

An operation method of the present invention is described as follows with FIG. 4.

Firstly, the outer swinging component 3 starts to swing under the action of the power input device, and meanwhile the pin shaft 33 (namely the second pivot A2) connected to a top of the supporters 31 of the outer swinging component 3 also swings. Correspondingly, the inner swinging component 4 swings, and meanwhile the inner swinging component 4 swings around the second pivot A2 with respect to the outer swinging component 3. A swing of the inner swinging component 4 following the second pivot A2 and a swing of the inner swinging component 4 with respect to the second pivot A2 are superposed, so that a swing of the sliding block structure 42 of the bottom of the inner swinging component 4 is amplified because of a lever principle. During swinging of the inner swinging component 4, the sliding block structure 42 of the bottom of each supporter 41 of the inner swinging component 4 moves relatively to every friction wheel 52 provided on the sides of the supporters 31 of the outer swinging component 3 or at the base 2, so as to drive the friction wheel 52 to rotate. Because of the above mentioned lever amplification effect, a relatively small external input is able to realize a high-speed rotation of the friction wheel 52. The high-speed rotation of the friction wheel 52 is outputted to the flywheel 61 by the side shaft 51, and the flywheel 61 further outputs the rotational energy to the power generation part 8 for converting the rotational energy into the electric energy.

According to the preferred embodiment of the present invention, the swing of the outer swinging component 3 with respect to the first pivot A1 is easily realized, and a relatively small force is able to drive the outer swinging component 3 to swing between the two deflection positions which are located at two sides of the equilibrium position. Thus, the present invention has a low requirement on the power input. The power generation device provided by the present invention obtains the redundant power easily and fully from the environment and converts the redundant power into the electric energy.

Under the lever amplification effect, the inner swinging component 4 is able to swing with a relatively large amplitude, so that the friction wheel 52 rotates with a high speed. Thus, the present invention is able to convert a relatively low power input into the electric energy highly-efficiently.

Moreover, the present invention easily adapts to a relatively high power input through increasing a size of the outer swinging component 3 and the inner swinging component 4, increasing a weight of the counterweight 43 of the inner swinging component 4, and increasing the amount of the outer swinging component 3 and the inner swinging component 4. When each supporter 31 of the outer swinging component 3 has a relatively high height, the second pivot A2 is able to swing with the relatively large amplitude, so that the inner swinging component 4 also swings with the relatively large amplitude. When the counterweight 43 of the inner swinging component 4 has a relatively large weight, the sliding block structure 42 of the inner swinging component 4 is able to exert a relatively large friction force to the friction wheel 52, so as to accelerate the rotation of the friction wheel 52. When a plurality of the power generation devices are provided in parallel, namely the amount of the supporters 31 of the outer swinging component 3 is more than two and at least one inner swinging component 4 is provided between each two adjacent supporters 31 of the outer swinging component 3, the energy outputted by the power generation devices is multiplied.

In order to maximally amplify a swinging amplitude of the inner swinging component 4, when the inner swinging component 4 swings to a maximum deflection position, the outer swinging component 3 preferably starts to swing in an opposite direction.

In order to save energy, it is feasible for the power input device to intermittently provide the power input. Merely when the inner swinging component 4 swings to the maximum deflection position, the power input device transitorily exerts the power to the outer swinging component 3.

Every triangular supporter 31 of the outer swinging component 3 has a size of 2500 mm×1200 mm. The bearing with a length of 25 mm is provided at the top point of each supporter 31 of the outer swinging component 3. Each two adjacent supporters 31 of the outer swinging component 3 has a distance of 100 mm and connected through a plurality of the connecting rods 32 having a diameter of larger than 25 mm. The power input device provides the power input with an intermittence of 0.5-1.5 seconds.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A pendulum-type lever power generation device, comprising a swinging device (1), wherein said swinging device (1) comprises:
a base (2);
an outer swinging component (3), which is connected to said base (2) at a first pivot (A1) and able to swing around said first pivot (A1) with respect to said base (2);
an inner swinging component (4), which is connected to said outer swinging component (3) at a second pivot (A2) and able to swing around said second pivot (A2) with respect to said outer swinging component (3), wherein said second pivot (A2) is different from said first pivot (A1); and
a friction device (5), which contacts said inner swinging component (4) in a relative sliding manner, so as to convert a swing of said inner swinging component (4) into a rotation of said friction device (5) around a third pivot (A3) and/or a fourth pivot (A4);
the pendulum-type lever power generation device further comprising:
a power input device, which is coupled to said outer swinging component (3) for driving said outer swinging component (3) to swing around said first pivot (A1); and
a power output device (6), which is coupled to said friction device (5) and a power generation part (8), so as to convert a rotational kinetic energy of said friction device (5) into an electric energy.

2. The pendulum-type lever power generation device, as recited in claim 1, wherein: said outer swinging component (3) comprises at least two supporters (31) which are connected with each other through connecting rods (32); a bottom of each supporter (31) is pivotally connected to said base (2), so as to form said first pivot (A1); and a pin shaft (33), which is pivotally rotatable, is provided between tops of said adjacent supporters (31), so as to form said second pivot (A2).

3. The pendulum-type lever power generation device, as recited in claim 2, wherein: each supporter (31) of said outer swinging component (3) is triangular; each supporter (31) is pivotally connected to said base (2) at a middle position of said bottom of each supporter (31); and said pin shaft (33) is located between top points of said adjacent supporters (31) of said outer swinging component (3).

4. The pendulum-type lever power generation device, as recited in claim 2, wherein said inner swinging component (4) is fixedly connected to said pin shaft (33) at a top of said inner swinging component (4).

5. The pendulum-type lever power generation device, as recited in claim 4, wherein: said inner swinging component (4) comprises a supporter (41) which is triangular; said supporter (41) of said inner swinging component (4) is fixedly connected to said pin shaft (33) at a top point of said supporter (41); and a bottom of said supporter (41) of said inner swinging component (4) has a sliding block structure (42).

6. The pendulum-type lever power generation device, as recited in claim 5, wherein a counterweight (43) is provided inside said supporter (41) of said inner swinging component (4).

7. The pendulum-type lever power generation device, as recited in claim 5, wherein: said friction device (5) comprises a side shaft (51) and a friction wheel (52) fixedly connected to said side shaft (51); said side shaft (51) limits said third pivot (A3) and/or said fourth pivot (A4); and said friction wheel (52) contacts said sliding block structure (42) in the relative sliding manner.

8. The pendulum-type lever power generation device, as recited in claim 7, wherein: said friction device (5) is provided between corresponding sides of said adjacent supporters (31) of said outer swinging component (3) or at said base (2).

9. The pendulum-type lever power generation device, as recited in claim 7, wherein said power output device (6) comprises a flywheel (61) which is connected to said side shaft (51) and said power generation part (8).

10. The pendulum-type lever power generation device, as recited in claim 1, wherein said power input device is connected to a top of said outer swinging component (3).

11. The pendulum-type lever power generation device, as recited in claim 2, wherein: said outer swinging component (3) comprises three or more than three supporters (31); and one inner swinging component (4) is provided between each two adjacent supporters (31).

12. A pendulum-type lever power generation method, comprising steps of:
providing an outer swinging component (3) having a first pivot (A1), an inner swinging component (4) having a second pivot (A2) which is different from the first pivot (A1), and a friction device (5);
providing a power input for swinging the outer swinging component (3) with respect to the first pivot (A1);
connecting the inner swinging component (4) to the outer swinging component (3) at the second pivot (A2), for driving the inner swinging component (4) to swing through a swing of the outer swinging component (3);
providing the friction device (5) at a position where the friction device (5) is able to contact the inner swinging component (4) in a relative sliding manner, for driving the friction device (5) to rotate through a swing of the inner swinging component (4); and
providing a power output, for converting a rotational kinetic energy of the friction device (5) into an electric energy.

13. The pendulum-type lever power generation method, as recited in claim 12, wherein: the first pivot (A1) is provided at a bottom of the outer swinging component (3), and the second pivot (A2) is provided at a top of the inner swinging component (4).

14. The pendulum-type lever power generation method, as recited in claim 12, wherein a rotational or translational power input is provided to a top of the outer swinging component (3), for swinging the outer swinging component (3) with respect to the first pivot (A1).

15. The pendulum-type lever power generation method, as recited in claim 14, wherein an intermittent rotational or translational power input is provided to the outer swinging component (3).

16. The pendulum-type lever power generation method, as recited in claim 14, wherein, when the inner swinging component (4) swings to a highest point, the outer swinging component (3) swings in an opposite direction.

17. The pendulum-type lever power generation method, as recited in claim 12, wherein: a plurality of supporters (31) which are connected with each other through connecting rods (32) are provided for the outer swinging component (3); and a height of the supporters (31) is determined according to the power input or an expected power output.

18. The pendulum-type lever power generation method, as recited in claim 12, wherein: a plurality of supporters (31) which are connected with each other through connecting rods (32) are provided for the outer swinging component (3); and an amount of the supporters (31) is determined according to the power input or an expected power output.

19. The pendulum-type lever power generation method, as recited in claim 12, wherein: a counterweight (43) is provided for the inner swinging component (4), and a weight of the counterweight (43) is determined according to the power input or an expected power output.
